(19) United States
(12) Patent Application Publication
(10) Pub. No.: US 2005/0171954 A1
(43) Pub. Date: Aug. 4, 2005

(54) Selective electronic messaging within an online social network for SPAM detection

(75) Inventors: Mark E. Hull, San Jose, CA (US); F. Randall Farmer, Palo Alto, CA (US); Ellen S. Perelman, San Francisco, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 10/946,630

(22) Filed: Sep. 21, 2004

Related U.S. Application Data
(60) Provisional application No. 60/540,505, filed on Jan. 29, 2004.
(60) Provisional application No. 60/544,639, filed on Feb. 13, 2004.

(51) Int. Cl. G06F 17/30

(52) U.S. Cl. 707/10

(57) ABSTRACT

A method, apparatus, and system are directed towards communicating a message within a social network based, in part, on user-defined criteria. The user-defined criteria may be applied towards filtering outgoing and/or incoming messages. The user-defined criteria may include degrees of separation between members of the social network, a relationship to the prospective recipient, as well as criteria based, in part, on activities, such as dating, employment, hobbies, and the like. The user-defined criteria may also be based on a group membership, a strength of a relationship, and the like. Such user-defined relationship criteria may then be employed to determine to whom a message may be sent, as well from whom a message may be received.

### CROSS-REFERENCE TO RELATED APPLICATIONS

This application claims the benefit of U.S. Provisional Application, titled “System and Method for Social Networking,” Ser. No. 60/544,639 filed on Feb. 13, 2004, and U.S. Provisional Application, titled “System and Method for Social Networking,” Ser. No. 60/540,505 filed on Jan. 29, 2004, the benefit of the earlier filing date of which is hereby claimed under 35 U.S.C. § 119(e) and are further incorporated herein by reference.

### FIELD OF THE INVENTION

The present invention relates generally to computing software, and more particularly, but not exclusively to a method and system for selective messaging within an online social network.

### BACKGROUND OF THE INVENTION

Social networking is a concept that an individual's personal network of friends, family colleagues, coworkers, and the subsequent connections within those networks, can be utilized to find more relevant connections for dating, job networking, service referrals, activity partners, and the like.

A social network typically comprises a person's set of direct and indirect personal relationships. Direct personal relationships usually include relationships with family members, friends, colleagues, coworkers, and other people with which the person has had some form of direct contact, such as contact in person, by telephone, by email, by instant message, by letter, and the like. These direct personal relationships are sometimes referred to as first-degree relationships. First-degree relationships can have varying degrees of closeness, trust, and other characteristics. These relationships can also be unidirectional or bidirectional. A unidirectional relationship typically means that a first person is willing and able to interact with a second person, but the second person may not be willing or able to interact with the first person. Conversely, a bidirectional relationship typically means that both people are willing and able to interact with each other.

Indirect personal relationships typically include relationships through first-degree relationships to people with whom a person has not had some form of direct contact. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as a second-degree relationship.

The above personal relationships, and others, can be utilized to find and develop relevant connections for a variety of objectives. Finding and developing relevant connections can be accelerated with online services. Such online social networking can be used to mine personal and/or interest relationships in a way that is often more difficult and/or time-consuming to do offline.

Thus, there has been a flurry of companies launching services that help people to build and mine their personal networks. However, these efforts have been predominately directed towards dating and job opportunities. Many of these companies are struggling with developing additional services that will build customer loyalty. Without the ability to extend the value of the existing networks, social networking loses its appeal. Thus, there is a need in the industry for better mechanisms to manage, mine, and use personal networks. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIGS. 3A-3B illustrate a logical flow diagram generally showing one embodiment of a process for managing social network user information; and

FIG. 4 illustrates a logical flow diagram generally showing one embodiment of a process for employing social network user information for selective messaging, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards providing a system, apparatus, and method for selective electronic messaging by employing, in part, social network user information. The social network user information may be used to determine a set of user-defined criteria employable to filter incoming messages. The user-defined criteria also may be employable to select potential recipients of an outgoing message. As such, the user-defined criteria may include any of a variety of social network user information, such as a degree of separation between members of the social network, a relationship between the prospective recipient, as well as activities, such as dating, employment, hobbies, and the like. The user-defined criteria may also be based on a group membership, a category membership, a strength of a relationship, and the like. Essentially, virtually any user-defined criteria may be developed to establish permissions using social network user information. Such user-defined criteria for example may be employed to determine whether a sender has permission to send the outgoing message to the selected potential recipients. In one embodiment, the social network user information may be further employed to determine whether a user has ‘opted-out’ of receiving messages from various senders.

The invention is not limited, however, to messaging between members of the social network. An owner of the social network system infrastructure, a business, and the like, may employ social network user information to determine whether they have permission to send a message to a member of the social network. For example, the owner, business, and the like, may employ the social network user information to determine whether there is permission to invite a member to participate in an online service; to solicit a member for information; to request a recommendation; to enable the owner, business, and the like; to market an opportunity; and similar actions.

Illustrative Operating Environment

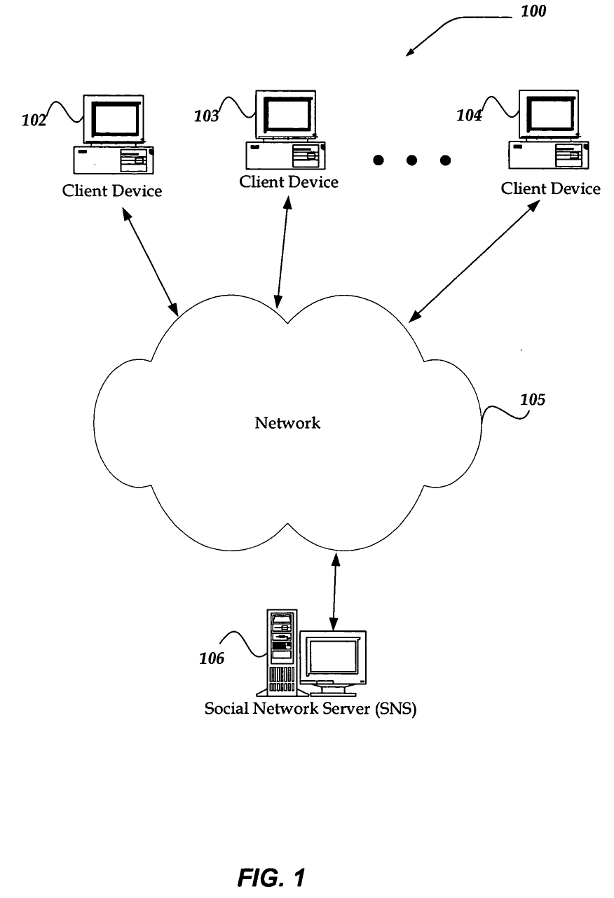

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 102-104, network 105, and social network server (SNS) 106. Network 105 is in communication with and enables communication between each of client devices 102-104, and SNS 106.

Client devices 102-104 may include virtually any computing device capable of receiving and sending a message over a network, such as network 105, to and from another computing device, such as SNS 106, each other, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 102104 may be any device that is capable of connecting using a wired or wireless communication medium such as a PDA, POCKET PC, wearable computer, and any other device that is equipped to communicate over a wired and/or wireless communication medium.

Each client device within client devices 102-104 may include a browser application that is configured to receive and to send web pages, web-based messages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Client devices 102-104 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

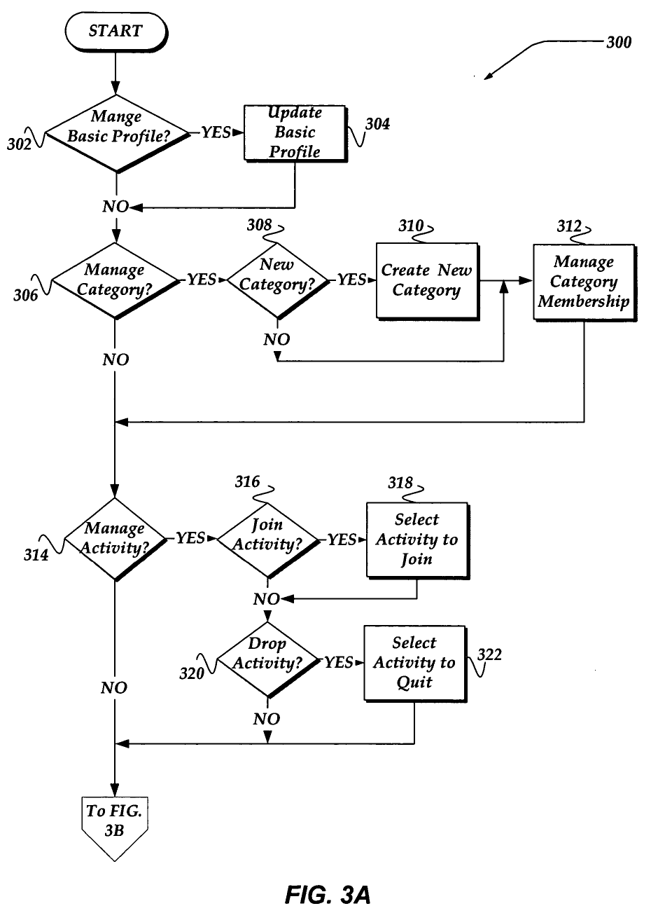

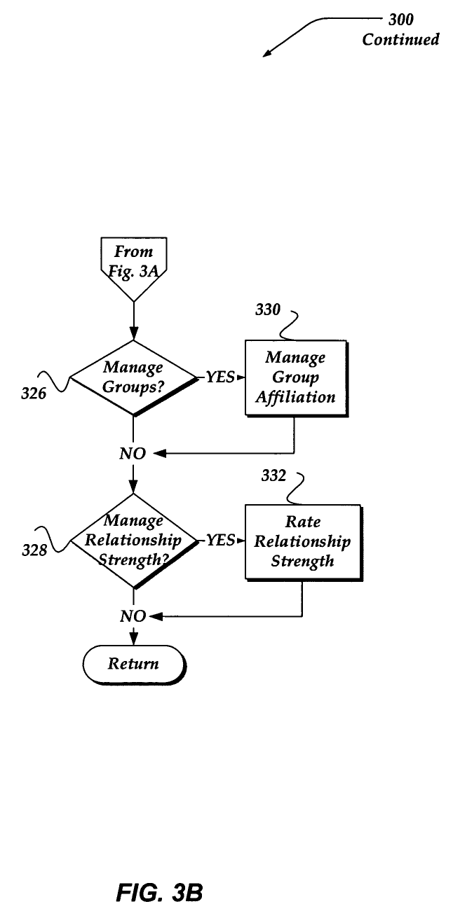

Client devices 102-104 may be further configured to enable a user to manage a user profile, category information, activity participation, and the like, which may in turn be saved at a location, such as SNS 106, and the like. As such, client devices 102-104 may further include a client application that is configured to manage various actions on behalf of the client device. For example, the client application may enable a user to interact with the browser application, email application, and the like, to manage a social network user's information. For example, the user may employ the client application, in part, to determine membership in a group, activity, and the like. The client application may interact with a process such as described below in conjunction with FIG. 3 to manage such social network user information.

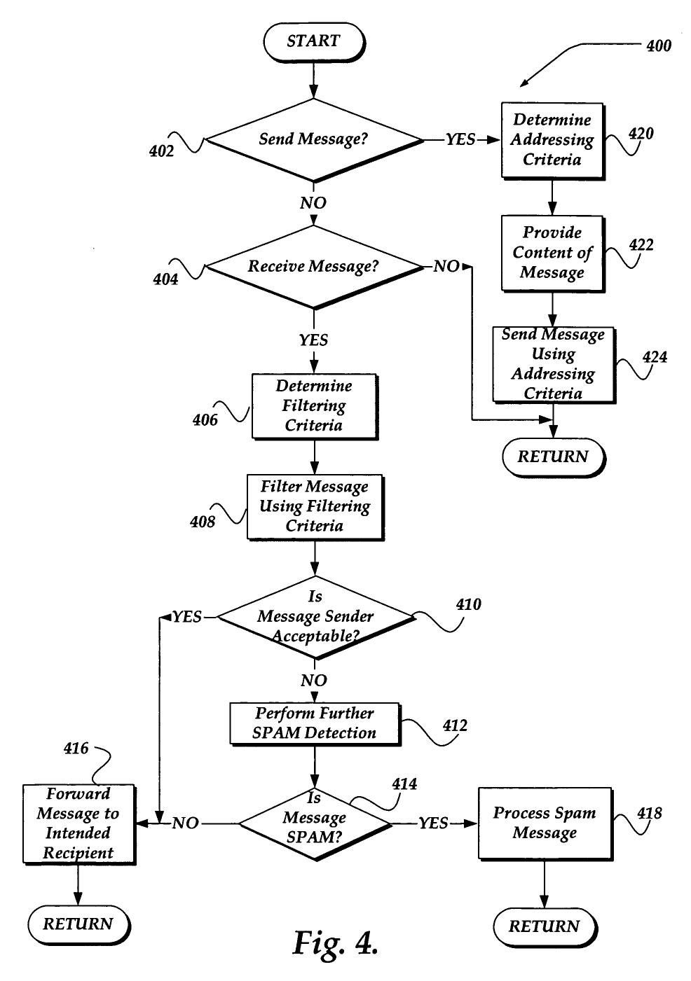

Additionally, client devices 102-104 may employ the social network user information to selectively manage messages. For example, the user of a client device may determine a set of user-defined criteria for filtering in-coming messages. The user-defined criteria may be determined based, in part, on social network user information. Moreover, the user may further employ another set of user-defined criteria that is based on the social network user information to determine a potential message recipient. For example, the user may select to send a message to those members of a particular activity that are within, say, two degrees of separation from the user. The user-defined criteria may further be employed to determine a permission to invite another member to participate in an online service, to solicit another member for information or contact referrals, and the like. These actions may be performed using the client application to interact with a process such as is described below in conjunction with FIG. 4.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between client devices 102-104, and SNS 106.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

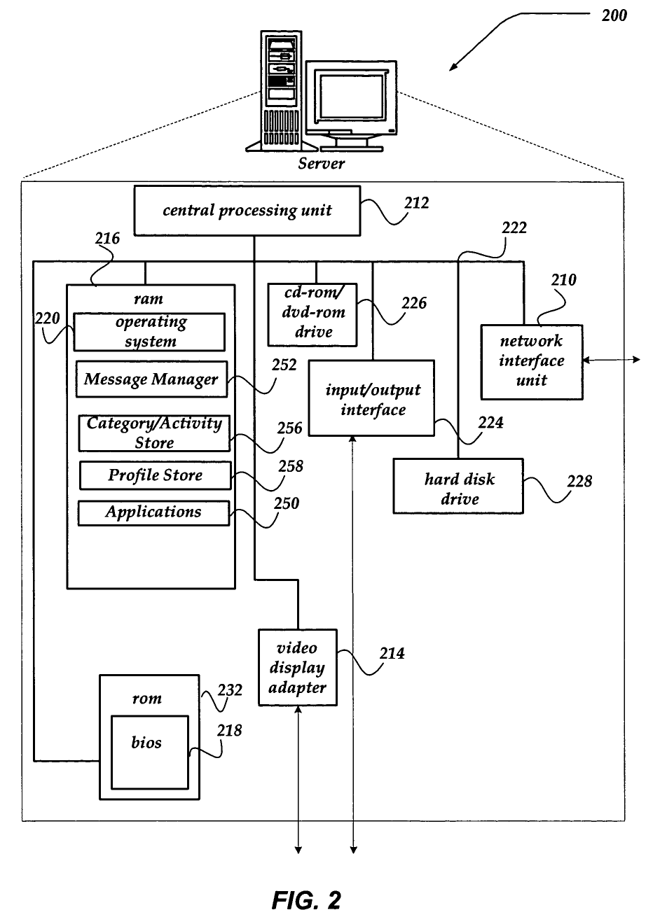

One embodiment of SNS 106 is described in more detail below in conjunction with FIG. 2. Briefly, however, SNS 106 may include any computing device capable of connecting to network 105 to enable a user of at least one of client devices 102-104 to manage their social network information and to further manage selective messaging by using social network user information. Devices that may operate as SNS 106 include personal computers desktop computers, multiprocessor systems, microprocessor-based or programmable consumer electronics, network PCs, servers, and the like.

SNS 106 may be configured to receive information associated with a user and to enable the user to manage components of their social network user information, based on the received information. The received information may include, but is not limited to, profile information, category information, an activity, membership information associated with a category, and the like.

SNS 106 may further determine additional social network information about the user that may be employed by the user for selective messaging. For example, SNS 106 may determine a degree of separation between the user and another member of the online social network. The degree of separation may be determined using a variety of information, including, but not limited to, a presence of a message address in a buddy list, an address book, another's address book, a mailing list, an online discussion group, a chat group, a category, an activity, and the like.

SNS 106 may also enable the user of a client device, such as client devices 102-104, to select a set of user-defined criteria based, in part, on social network user information. The user-definable criteria may include, but is not limited to, degrees of separation, a rating of a relationship (such as friend, family, colleague, and the like), as well as any assessment of closeness, trust, and the like, based on information about the relationship between the social network user and another social network user, and the like. The received user-defined criteria may further include a relationship strength, an offline group affiliation, an online group affiliation, and the like.

Based, in part, on the user-defined criteria, SNS 106 is configured to enable the user to filter incoming messages, determine a potential recipient for an outgoing message, and the like. SNS 106 may enable a user to employ processes such as described in more detail below in conjunction with FIGS. 3-4 to manage components of their social network user information and to further perform selective messaging based on social network information.

SNS 106 may be configured to further enable an owner of the social network infrastructure, a business, and the like to determine a permission to send a message to a member of the social network. Such messages may include, for example, an invite to a member to participate in a service; to solicit a member for information, to market a product and/or a service to a member, and the like.

Illustrative Server Environment

FIG. 2 shows one embodiment of a server device, according to one embodiment of the invention. Server device 200 may include many more components than those shown. The components shown, however, are sufficient to disclose an illustrative embodiment for practicing the invention.

Server device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server device 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, transcoders, database programs, word processing programs, spreadsheet programs, and so forth. Mass storage may further include applications such as message manager 252, category/activity store 256, and profile store 258.

Category/activity store 256 may include a database, text, folder, file, and the like, that is configured to maintain and store information that identifies a category, activity, and the like. While category/activity store 256 may store identification information, profile store 258, described below, may store profile and user-definable criteria information for each social network user.

A category may represent a classification of users within a user's social network, such as friends, co-workers, poker buddies, family, fishing buddies, and the like. Typically, social network users establish their own categories and profile information based on the category that may be accessible to those identified by the creating social network user. However, the invention is not so limited, and global categories may be established that provide profile information about a social network user to virtually any other social network user. Each category may include a set of social network user information. When the category is user-definable, the set of social network user information (profile information) may also be user-definable. For example, the user may determine that social network user information associated with hobbies may be included in a category for sports, while it may be excluded from a category associated with religion, and the like.

Category/activity store 256 may further include information associated with a group affiliation. For example, the user may establish groupings based on whether another social network user is affiliated with a predetermined group. Such group affiliations may include, but are not limited to, online groups, such as a Yahoo! group, and the like, as well as an offline group, such as Fly Fishing club, a chess club, a bridge club, a bowling group, and the like.

An activity may include virtually any way, manner, and the like, in which a social network user may select to employ their social network connections. For example, activities may include, but are not limited to, dating, careers, military, alumni, help, advice, expertise, and the like. Typically, an activity may be employed by other social network users, even though they are not a member of the activity. As such, it may be desired, although not required, that an activity be globally configured and managed. Additionally, at least a minimum set of profile information associated with the activity may be globally established. For example, if the activity includes dating, the minimum set of profile information, may include, but is not limited to age, sexual preference, information associated with one's physical appearance, and the like. If the activity includes job search, employment search, and the like, the minimum set of profile information may include, but is not limited to, job history, salary desired, job qualifications, experience, and the like. However, an activity may further include an optional set of profile information, such as achievements, hobbies, recommendations, and the like. Moreover, membership to an activity may also be employed to determine whether a message is spam.

Profile store 258 may include a database, text, folder, file, and the like, that is configured to maintain and store a profile associated with a social network user. A profile may include information associated with the social network user. For example, the profile may include, but is not limited to such information as the social network user's name, alias, nickname, age, email address, and the like. In one embodiment, a collection of such information may be arranged to provide a basic profile for the social network user. Additional information may also be included in profile store 258 that includes category profile information, activity profile information, group profile information, relationship strength profile information, degree of separation data based on a variety of other information, and the like. Additional information may further include, but is not limited, to a photograph, a hobby, a job history, a school history, career information, dating information, military information, sports information, religious information, sexual orientation, politics, interests, favorite sites, self-description, and the like. In one embodiment, at least some information includes a Universal Resource Locator (URL). Virtually any information associated with the social network user may be included within profile store 258.

Moreover, profile store 258 may store and maintain criteria about relationships between the social network user and another social network user. For example, the present invention enables the social network user to establish criteria that is based on a relationship between another social network user and the user. The relationship criteria may then be employed to map various collections, groupings, sets, and the like, of profile information, which may in turn be employed for selective messaging, and the like. As such, the social network user, for example, may establish criteria such that any message sent by another social network user that is within some predetermined degrees of separation may be received by the social network user. However, the invention is not limited to the above examples, and virtually any criteria, rating, and the like, may be employed to enable selective messaging.

Message manager 252 is configured to enable a social network user to use their information within profile store 258 and category/activity store 256. Message manager 252 may, for example, enable the social network user to employ the social network user information to select various user-defined criteria to filter incoming messages, to further select candidate recipients of outgoing messages, and the like. Message manager 252 may employ a process such as described in more detail below in conjunction with FIG. 4 to manage how the social network user receives and sends messages.

Although illustrated in FIG. 2 as distinct components in server device 200, message manager 252, category/activity store 256, and profile store 258 may be arranged, combined, and the like, in any of a variety of ways, without departing from the scope of the present invention. For example, category/activity store 256 may be arranged as separate components, such as an activity store and a category store, or the like. Moreover, message manager 252, category/activity store 256, and profile store 258 may reside in one or more separate computing devices, substantially similar to server device 200.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. Likewise, server device 200 may further include additional mass storage facilities such as CD-ROM/DVD-ROM drive 226 and hard disk drive 228. Hard disk drive 228 is utilized by server 102 to store, among other things, application programs, databases, message manager 252, category/activity store 256, profile store 258, and the like.

Generalized Operation

The operation of certain aspects of the present invention will now be described with respect to FIGS. 3-4. Briefly, FIGS. 3A-3B illustrate a logical flow diagram generally showing one embodiment of a process for enabling social network users to manage their profile information. Process 300, which spans FIGS. 3A-3B, may be implemented, for example, within SNS 106 of FIG. 1, and accessed employing a client device, such as client devices 102104 of FIG. 1.

Process 300 is typically entered when a social network user that is registered to employ the process indicates intent to manage their social network information. Thus, process 300 begins, after a start block, at decision block 302, where a determination is made whether the social network user wishes to manage their basic profile. Typically, if the social network user has not provided basic user profile information, such as when the user has just registered, or the like, then the answer to decision block 302 may be yes. In any event, if it is determined that the social network user is to manage their basic profile, processing branches to block 304; otherwise, processing continues to decision block 306.

In one embodiment, the user profile may be created quickly by automatically importing predetermined user data from a variety of sources, including, but not limited to, the user's email address book, group associations, instant messaging buddy list, an online discussion group, a chat group, and the like.

At block 304, the social network user may update their basic profile. Updates may include, modifying basic profile information about themselves, including age, gender, email address, interests, and the like. Basic profile information is not limited to these items, however, and others may be included, substituted, or the like, without departing from the scope of the invention. For example, basic profile information may include enabling/denying permission to another member to/from including the social network user as a recipient to a message. In any event, upon updating the basic profile information, process 300 continues to decision block 306.

At decision block 306, a determination is made whether the social network user is to manage a category. As described above, a category includes a classification of social network users within an individual user's social network. Typically, the social network users are within the user's first degree of separation, such as friends, soccer teammates, co-workers, family, and the like. A degree of separation is one criterion that may be employed to represent a relationship between social network users. Degrees of separation, for example, may indicate that the two social network users have a direct relationship, such as through direct email correspondences, inclusion of each other's email addresses within one's address book, or the like. Higher degrees of separation may indicate a further removed relationship, such as a friend of a friend, and the like. Thus, the present invention is not limited to first degrees of separation, and higher degrees may be employed without departing from the scope of the invention. Such categories are directed towards providing a convenient mechanism to organize one's connections, and control information that is revealed to others, to efficiently manage communications, such as enabling email to all social network members in one's soccer teammate's category, and the like. Moreover, categories may be employed to minimize the likelihood of receiving spam. For example, a category may be employed in conjunction with a spam filter to determine whether a message is from a member of a category. However, use of a category is not limited to these spam examples, and others may be employed without departing from the scope of the invention. As such, managing a category includes the ability to create, edit, and delete a user specified category. In any event, if the determination is to manage a category, processing branches to decision block 308; otherwise, processing proceeds to decision block 316.

At decision block 308, a determination is made whether the user indicates intent to create a new category. If the user indicates intent to create a new category, processing proceeds to block 310, where the new category is created; otherwise, processing branches to block 312. Creation of a new category may include providing a name to the category, a description of the category, and the like. The category may also be created when another social network user includes the current user in their social network. Processing next proceeds to block 314.

At block 312, membership to the category is managed. Based, in part, on any of a variety of criteria, membership may be added or deleted. For example, membership to a category may have been established based on a relationship, such as any person within two degrees of separation from this other person. However, membership is not constrained to this example, and virtually any criteria, and the like, may be employed to determine membership to a category. Additionally, membership may be obtained from virtually any source, including, but not limited to, one's email address book, another's address book, a buddy list, a database, an association, and the like. Membership may also be revised based on additional user input at this block, including revising selected member participation, further revising membership criteria, revising other connections between online portal subscribers, and the like. In any event, upon completion of block 312, processing proceeds to decision block 314.

At decision block 314, a determination is made whether the user indicates intent to manage membership within an activity. If the user indicates intent to manage membership within an activity, processing continues to decision block 316; otherwise, process 300 flows to decision block 326 of FIG. 3B.

At decision block 316, a determination is made whether the user indicates intent to join an activity. Activities are typically predetermined so as to enable other social network users to perform searches, make inquiries, selectively managing messages, and the like. As such, activities are typically, but not necessarily, accessible to virtually any social network user that wishes to join. Moreover, activities are typically, but not necessarily, managed by other than the single user. Thus, if the user indicates intent to join an existing activity, processing continues to block 318, where the user is presented with at least one predetermined activity for which the user may join. Otherwise, if the user does not intend to join an activity, processing continues to decision block 320. Such activities may include, but are not limited to, dating, careers, military, alumni, help, advice, expertise, and the like. Upon completion of block 318, processing continues to decision block 320.

At decision block 320, a determination is made whether the user indicates intent to be removed from an activity for which the user is already a member. If so, processing proceeds to block 322, where the user selects the activity from which the user indicates intent to be removed. Upon completion of block 322, or if the answer is not to drop an activity, processing flows to decision block 326 of FIG. 3B.

At decision block 326 of FIG. 3B, a determination is made whether the user indicates an intent to manage a group affiliation. If so, processing proceeds to block 330; otherwise, processing branches to decision block 328.

At block 330, a group affiliation is identified. The user may provide the group affiliation based on an online group, club, and the like, based on an offline group, club, association, and the like. For example, a group affiliation may be based on another's affiliation to an offline fly-fishing club, a chess club, an online fly-fishing club, a group such as a Yahoo! group, and the like. Virtually any affiliation may be employed to establish group affiliation criteria. Upon completion of block 330, processing continues to decision block 328.

At decision block 328, a determination is made whether a relationship strength is to be managed. If so, processing flows to block 332; otherwise, processing returns to a calling process to perform other actions.

At block 332, a relationship strength is rated. Virtually any rating of a relationship may be employed. In one embodiment, however, a rating is based on inputting a criterion, for another social network user. For example, a rating may be applied that distinguishes a “close friend” from a “casual acquaintance,” and the like. Upon completion of block 332, processing returns to the calling process to perform other actions.

Upon completion of process 300, the social network system, perhaps, as directed by SNS 106 of FIG. 1, updates additional relationship information for the social network user. Such relationship information may include, but is not limited to, updating degrees of separation between the social network user and other members of the online social network system. Degrees of separation may also be updated on an on-going basis, as a social network user performs actions within the social network system. Such actions that may affect a degree of separation, include, but are not limited to, process 300 actions, accepting a message from another social network user, rejecting a message from another social network user, sending a message to another social network user wherein the other social network user rejects the message or accepts the message, indicating that a message is spam, and the like.

FIG. 4 illustrates a logical flow diagram generally showing one embodiment of a process for employing social network user information for selective messaging. Process 400 of FIG. 4 may be implemented, for example, on SNS 106 of FIG. 1.

Process 400 begins, after a start block, at decision block 402, where a determination is made whether the social network user indicates intent to send a message. If so, processing branches to block 420; otherwise, processing continues to decision block 404.

At block 420, the social network user determines a set of user-definable addressing criteria. Such addressing criteria may include, but is not limited to; a degree of separation; a strength of relationship, such as close friend, family, colleague, and the like; membership within a category, an activity; and the like. Virtually any addressing criteria may be employed, including criteria that one might employ to perform a search within the social network system. For example, the social network user may determine an addressing criterion that includes female members of a dating activity that are between a particular age range, and identified income range. Moreover, the user-definable addressing criteria may include a set of criteria. In any event, upon completion of block 420, processing moves to block 422, where the social network user provides content for the message. The content of the message may include virtually any information, including, for example, an invite to participate in a service, purchase a product and/or a service, a solicitation for user information, a request for a contact referral, and the like. In any event, processing then continues to block 424, where the message is sent using the user-defined addressing criteria of block 420 to determine the potential recipients' addresses. In one embodiment, at block 424, a potential recipient's address may be deleted based on an opt-out by the potential recipient, based on the user-defined addressing criteria, and the like. In another embodiment, at block 424, the social network user may view the recipients' addresses and provide modifications, deletions, additions, and the like. In another embodiment, at block 424, although not shown, should the social network user desire to modify the determined addressing criteria, the process may loop back to block 420. In any event, if the social network user determines that the determined addresses are satisfactory, the message is sent. Upon completion of block 424, processing returns to a calling process to perform other actions.

At decision block 404, however, a determination is made whether the social network system has received a message for the social network user. If the social network system has received a message, processing proceeds to block 406; otherwise, processing returns to the calling process to perform other actions.

At block 406, incoming message filtering criteria is determined. In one embodiment, the social network user provides the message filtering criteria in an out-of-band activity. That is, the social network user may determine the message filtering criteria once and it is applied to all future incoming messages, that is, until the social network user modifies them. In another embodiment, the social network user is periodically asked to update the message filtering criteria.

Message filtering criteria may include virtually any of a variety of user-definable criteria for filtering an incoming message. For example, the message filtering criteria may include a criterion that permits only messages to be received that are from a sender address that is within a particular degree of separation, from a particular category, a particular activity, and the like. Moreover, the user-definable criteria may include a set of criteria. In any event, at block 406, the social network system determines the message filtering criteria that may have been saved in a storage location, recently modified, currently provided by the social network user, and the like. Processing next proceeds to block 408, where the determined message filtering criteria is employed to filter the incoming message(s). Messages may be further filtered based, in part, on an opt-out criteria and similar permission and/or denial of permissions to send the message.

Processing continues next to decision block 410, where a determination is made whether the message sender address is acceptable based on the results of the filtering performed at block 408. If the message is not acceptable according to the message filtering criteria, processing flows to block 412; otherwise, processing flows to block 416.

At block 412, further analysis of the incoming message may be performed. For example, as illustrated, additional spam detection is performed that may include executing an additional analysis of the content of the message, the message sender address, and the like. Processing then continues to decision block 414, where the results of block 412 are employed to make a determination of whether the incoming message is a spam message. If it is determined to be a spam message, processing flows to block 418; otherwise, processing flows to block 416.

At block 418, the incoming message is processed as a spam message. In one embodiment, the message may be discarded. However, the invention is not so limited, and other actions may be implemented, such as alerting the social network user, placing the sender's address on a spammer address list, notifying a social network system's administrator, moving the incoming message to a spam inbox folder, and the like. In any event, upon completion of block 418, processing returns to the calling process to perform other actions.

At block 416, the incoming message is forwarded to the social network user. In one embodiment, the incoming message is moved to an inbox associated with the social network user. In any event, upon completion of block 416, processing returns to the calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A method of communicating a message over a network, comprising:
determining social network user information associated with members of an online social network;
determining an addressing criteria that is based, at least in part, on the social network user information;
automatically selecting a message destination address employing the addressing criteria; and
sending the message to the selected message destination address.

2. The method of claim 1, wherein determining an addressing criteria further comprises selecting a relationship between a message sender and the members of the online social network.

3. The method of claim 2, wherein the relationship further comprises member information associated with a participation in at least one of an online friend matching service, an online dating service, an online job searching service, an online classmate searching service, an online military colleague searching service, an online club, an online financial service, an online auction, and a online purchase.

4. The method of claim 2, wherein the social network information further comprises at least one of an email address, an address book of the subscriber, another address book of at least one other member within the portal, a buddy list, an instant messaging buddy list, an activity, a mailing list, an online discussion group, a chat group, a master contact list, and user-defined information.

5. The method of claim 2, where the addressing criteria further comprises at least one of a degree of separation between at least two members of the online social network, a category membership, a group membership, a relationship strength, and an activity relationship between a sender of the message and the at least one member of the online social network.

6. The method of claim 1, wherein the addressing criteria further comprises a relationship associated with at least one of dating, business, military, employment, help, advice, expertise, and alumni.

7. The method of claim 1, wherein automatically selecting a message destination address further comprises searching social network user information for the at least one member that satisfies the addressing criteria and using the member message address of the at least one member in a message destination field of the message.

8. The method of claim 1, wherein automatically selecting a message destination address further comprises determining whether the selected message destination address has denied permission to receive the message from a sender of the message.

9. The method of claim 1, wherein the message further comprises at least one of marketing information, an invitation to participate in a service, a solicitation for information, and a request for a contact referral.

10. The method of claim 1, wherein the automatically selecting a message destination address further comprises determining whether the selected message destination address has opted-out of receiving the message.

11. The method of claim 1, further comprising providing content to the message.

12. A client device adapted to communicate a message within an online social network, comprising:
a display configured to view the message; and
a client application coupled to the display, that is configured to perform actions, including:
determining an addressing criteria that is based, at least in part, on a relationship between a sender of the message and a member of the online social network;
automatically selecting a message destination address employing the addressing criteria; and
sending the message to the selected message destination address.

13. The client device of claim 12, wherein the client device is a mobile device.

14. The client device of claim 12, wherein the relationship between the sender and the member is identifiable based on at least one of an email address, an address book of the subscriber, another address book of at least one other member within the portal, a buddy list, an instant messaging buddy list, an activity, a mailing list, an online discussion group, a chat group, a master contact list, and user-defined information.

15. The client device of claim 12, wherein the addressing criteria further comprises at least one of a rating, a degree of separation, and strength of a relationship.

16. The client device of claim 12, wherein the sender is a member of the online social network.

17. The client device of claim 12, wherein the relationship further comprises information associated with whether the member is identified as a spammer.

18. The client device of claim 12, wherein the addressing criteria further comprises identification of a relationship that includes at least one of a membership in a common group, activity, category, buddy list, mailing list, online discussion group, chat group, master contact, and an offline club.

19. A server for communicating a message within an online social network, comprising:
a transceiver for receiving and sending information to a computing device; and
a message manager that is configured to perform actions, including:
determining an addressing criteria that is based, at least in part, on a relationship between a message sender and a plurality of members of the online social network;
automatically selecting a message destination address by employing the addressing criteria to search for a member in the plurality of members; and
sending the message to the selected message destination address.

20. The server of claim 19, wherein the computing device is a mobile device.

21. The server of claim 19, the relationship further comprises at least one of a membership in a common group, activity, category, buddy list, mailing list, online discussion group, chat group, master contact, and an offline club.

22. The server of claim 19, wherein the relationship further comprises at least one of a degree of separation, and a strength of the relationship.

23. The server of claim 19, further comprising:
receiving another message from a message source address;
determining a message filtering criteria based, in part, on another relationship between a message recipient and the members in the plurality of members; and
if a member associated with the message source address is acceptable based on the message filtering criteria, forwarding the received message to the message recipient.

24. The server of claim 23, wherein the message filtering criteria further comprises a relationship based in part on a common group, activity, category, buddy list, mailing list, online discussion group, chat group, master contact, and an offline club.

25. The server of claim 23, wherein the message filtering criteria further comprises an opt-out criterion.

26. A modulated data signal for communicating a message within an online social network, the modulated data signal comprising:
enabling a determination of an addressing criteria that is based, at least in part, on a relationship between a message sender and members in a plurality of members of the online social network;
enabling an automatic selection of a message destination address associated with a member of the plurality of members by employing the addressing criteria to search for the member in the plurality of members; and
sending the message to the selected message destination address.

27. The modulated data signal of claim 26, wherein, at least a portion of the modulated data signal is communicated to a mobile device.

28. The modulated data signal of claim 26, wherein the relationship further comprises a relationship determinable based on at least one of a degree of separation, a strength of the relationship, and a rating, of the relationship.

29. The modulated data signal of claim 26, wherein automatic selection of the message destination address further comprises searching for the message destination address based, in part, on social network user information.

30. The modulated data signal of claim 26, further comprising:
receiving a different message from a message source address;
determining a message filtering criteria based, in part, on another relationship between a message recipient and the members in the plurality of members; and
if a member associated with the message source address is acceptable based on the message filtering criteria, forwarding the received message to the message recipient.

31. The modulated data signal of claim 26, further comprising if the member is unacceptable based on the message filtering criteria, determining if the different message is spam.

32. An apparatus for communicating a message within an online social network, comprising:
a means for determining an addressing criteria that is based, at least in part, on a means for identifying a relationship between a message sender and another member in the online social network;
a means for automatically selecting a message destination address associated with the other member based, in part, on the addressing criteria;
a means sending the message to the selected message destination address;
a means for receiving a different message from a message source address;
a means for determining a message filtering criteria based, in part, on a means for identifying another relationship between a message recipient and the members in the plurality of members; and
if a member associated with the message source address is acceptable based on the message filtering criteria, a means for forwarding the received message to the message recipient.
